(19) United States
(12) Patent Application Publication
(10) Pub. No.: US 2013/0041069 A1
(43) Pub. Date: Feb. 14, 2013

(54) DIGITAL PRINTING COMPOSITION

(71) Applicants: Doris Pik-Yiu Chun, Palo Alto, CA (US); Hou T. Ng, Palo Alto, CA (US)

(72) Inventors: Doris Pik-Yiu Chun, Palo Alto, CA (US); Hou T. Ng, Palo Alto, CA (US)

(73) Assignee: Hewlettt-Packard Development Company, L.P., Fort Collins, CO (US)

(21) Appl. No.: 13/643,016

(22) PCT Filed: Apr. 30, 2010
(86) PCT No.: PCT/US10/33268

§ 371 Date: Oct. 23, 2012

(51) Int. Cl. C09D 11/10; C08K 5/098

(52) U.S. Cl. 523/171; 524/570; 524/571; 524/543; 524/556; 524/567; 524/398; 524/400

(57) ABSTRACT

A digital printing composition includes a carrier and a colorant. The carrier includes a hydrocarbon having at least one unsaturated bond. The hydrocarbon is configured to at least one of polymerize or crosslink in the presence of a charged species produced from a corona generator.

### BACKGROUND

The present disclosure relates generally to digital printing compositions.

Digital printing is a process that generally involves reproducing a digital or computerized image onto a print medium. This process is typically accomplished using a digital printing system that utilizes electrical charges to transfer a printing composition (such as an ink, a toner, or the like) onto the print medium during printing. The transferred printing composition forms an image on the medium, where the image substantially identically reflects the original digital or computerized image.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a schematic illustration (not drawn to scale) of an embodiment of a print including an embodiment of a printing composition established on a substrate;

FIG. 2 is a schematic illustration of an embodiment of a digital printing system used in forming an embodiment of a print, such as the one depicted in FIG. 1;

FIG. 3 is schematic illustration of another embodiment of a digital printing system used in forming an embodiment of a print, such as the one depicted in FIG. 1;

FIG. 4 is a photograph depicting the spreading of an embodiment of the ink after exposure to corona discharge and removal of unexposed ink; and

FIGS. 5A and 5B are photographs depicting the results of a highlighter smear test for a printed ink sample using an embodiment of the ink composition disclosed herein (shown in FIG. 5A), and a comparative ink sample (shown in FIG. 5B).

### DETAILED DESCRIPTION

Embodiments of the digital printing composition as disclosed herein generally include a carrier or, in some embodiment(s), a carrier having a colorant dispersed or mixed therein. The carrier is configured to be directly crosslinked and/or polymerized (which may be the result of extensive crosslinking) in the presence of a charged species, and then transferred onto the surface of the desirable print medium or substrate. The polymerizing and/or crosslinking of the carrier results in the formation of a polymer matrix, which may, in some cases, be a thin film or layer having a substantially continuous polymer network (i.e., film or layer in which the polymer coverage extends over a length or diameter of at least 100 μm). It is to be understood, however, that the resulting polymer matrix may be printed in any desirable pattern, including dot patterns (e.g., where each dot has a diameter of at least 5 μm), line patterns (e.g., where each line has a width of at least 5 μm), or any other desirable geometric pattern. In embodiment(s) where the printing composition includes a colorant, the initial polymerizable and/or crosslinkable carrier serves as a medium that suspends the colorant therein. As polymerization and/or crosslinking occurs, the colorant becomes embedded in the resulting solid polymerized and/or crosslinked matrix of the carrier. More specifically, the solid polymer/crosslinked matrix provides a network to suspend and retain the colorant, which protects the colorant from physical damage, such as, e.g., rubbing and scratching, and enhances the water and solvent fastness of the prints. As such, this embedded colorant configuration advantageously protects the printed image (i.e., the polymer matrix transferred to the substrate surface) at least against chemical and/or physical deterioration caused, for example, from oxidation, exposure to moisture, and rub or highlighter smearing.

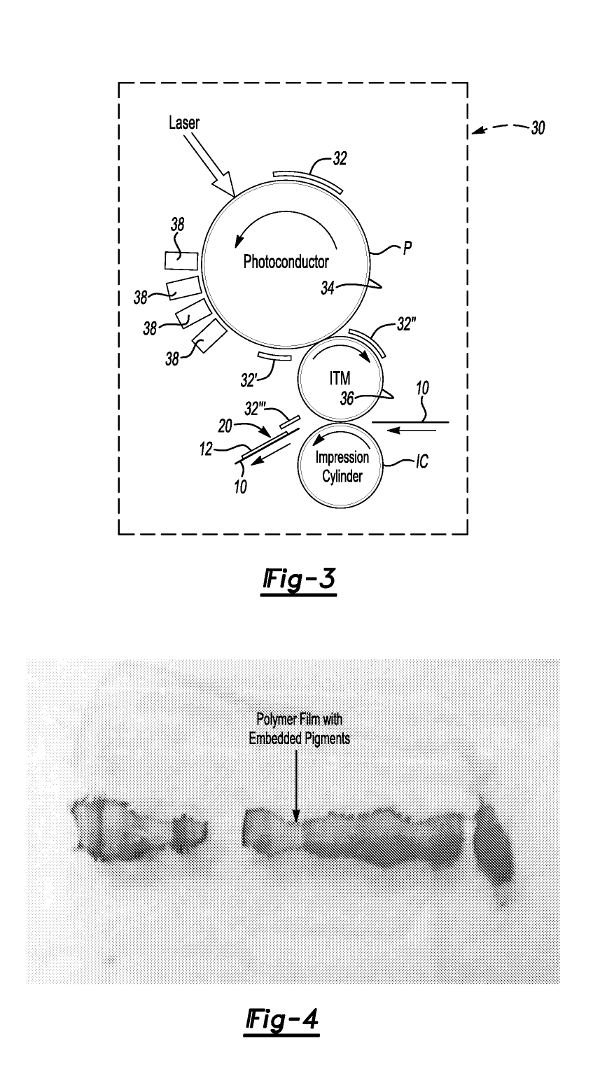

As used herein, a “digital printing composition” is a liquid composition, a solid composition, or a composition having a phase that is between a liquid and a solid (e.g., a paste), where any of the compositions is printable via a digital printer or printing system. Non-limiting examples of digital printers or printing systems include digital inkjet printers, digital laser printers, electrophotographic printers, or combinations thereof having at least two corona generators (as described further herein in reference to FIGS. 2 and 3).

As will be described in further detail below, the composition may be a fixer or gloss enhancer, an ink, or a toner. As such, some embodiments of the printing composition include, in its simplest form, a carrier. In other embodiments, the printing composition includes the carrier and a colorant. In still other embodiments, the printing composition includes the carrier, the colorant, and a dispersant (e.g., to further enhance ink stability). In yet further embodiments, it may be desirable to also add solvents, such as long chain alcohols (i.e., number of carbon is greater than 6) and alkane diols and polymeric additives (e.g., oil-soluble polymers). Still further, it may be desirable that some of the embodiments of the printing composition disclosed herein may or may not include other additives, such as, e.g., binder, solvents, surfactants, etc. The addition or elimination of additives from the compositions disclosed herein will depend, at least in part, upon the jetting technique used. For example, when jetting the oil-based inks thermally, nucleation agents, such as the previously mentioned alcohols may be desirable; and when jetting the oil-based inks with a piezoelectric printhead, polymers may be used to increase the viscosity. Generally, the total solvent, when used, will be present in an amount less than 10 wt. % of the total wt. % of the composition; and/or the total binder, when used, will be present in an amount less than 5 wt. % of the total wt. % of the composition.

The carrier present in the embodiments of the composition disclosed herein may be a liquid, a solid, or a phase between a liquid and a solid (such as, e.g., a paste) depending, at least in part, upon the digital printing system to be used. When a solid carrier is utilized, it is to be understood that the heat generated during printing melts the solid carrier to enable printing. Such solid carriers may begin to re-solidify on their own due to the decrease in temperature after melting and printing. However, it is believed that exposing the melted and printed previously-solid carrier to a charged species may decrease the time for the re-solidification process by initiating or enhancing (i.e., speeding up) polymerization and/or crosslinking.

In embodiments of the composition in which the carrier alone is utilized (i.e., no colorant, dispersant, or other additive is present), the printing composition is a fixer fluid or a gloss that includes a substantially optically transparent liquid or solid that melts during printing. In such embodiments, the “substantially optically transparent carrier” is a hydrocarbon (initially in liquid, solid, or paste form) that, when printed, does not exhibit or exhibits minimal color, and/or transmits more than 90% of light (in the visible spectrum range) incident thereon. The substantially optically transparent carrier may therefore be completely transparent, or may be a slight variation thereof. When colorants are added to the substantially optically transparent carrier, the composition exhibits the shade or hue of the colorant used.

For liquid-based, solid-based, and paste-based carriers, the carrier generally includes a hydrocarbon polymer precursor (also referred to herein as a “hydrocarbon”) that is configured to, from its liquid form, polymerize and/or crosslink in the presence of a charged species. More specifically, the embodiments of the carrier disclosed herein each include a hydrocarbon having at least one degree of unsaturation. In an example, the hydrocarbon includes a single unsaturated bond (i.e., a C═C bond). In other embodiments, the hydrocarbon includes two, three, or more unsaturated bonds. It is to be understood that, for these other embodiments, the hydrocarbon may have as many unsaturated bonds as is desirable. It is to be understood that any hydrocarbon having one or more unsaturated bonds may be used as the carrier so long as the hydrocarbon will polymerize and/or crosslink in the presence of the charged species. It is to be further understood that the hydrocarbon is also printable via a digital printer or printing system (i.e., where the hydrocarbon, when incorporated into the printing composition, can be printed without clogging the nozzles of the printhead or other fluid flow components of the system, etc.). Printable hydrocarbons may be selected from those having a viscosity ranging from about 5 cP to about 100 cP. For printing systems utilizing printheads (e.g., thermal or piezoelectric printheads), the hydrocarbons may be selected from those having a viscosity ranging from about 10 cP to about 35 cP. Furthermore, the surface tension of the hydrocarbon desirably ranges from about 24 dynes/cm to about 30 dynes/cm. In some cases, the elasticity is also a factor in selecting the hydrocarbon for the carrier.

Some specific examples of hydrocarbons that may be used in embodiments of the printing composition disclosed herein are now provided. In one example, the hydrocarbon may be an oil. In an example, the oil is selected from a dielectric material having a conductivity up to 200 pS/cm. In another example, the oil has a conductivity of equal to or less than 1 pS/cm. Examples of suitable oils include, but are not limited to unsaturated fatty acids, glycerides, or combinations thereof, some non-limiting examples of which include: 1-palmitoyl-2-oleoyl-glycerol; capric glycerides (such as those of the MIGLYOL® series manufactured by Sasol, Johannesburg, South Africa); glycerol stearates (such as those of the IMWITOR® series also manufactured by Sasol); Linseed oil; and combinations thereof.

In another example, the hydrocarbon is selected from those where one or more of the unsaturated bond(s) is/are conjugated. Some non-limiting examples of these hydrocarbons include: dienes (i.e., polyunsaturated fatty acids containing conjugated double bonds such as Omega 3, Omega 6, and Omega 9 acids); enones (e.g., methyl vinyl ketone and chalcone); or terminal olefins. Non-limiting examples of terminal olefins include styrenes (e.g., styrene, methylstyrene, vinylstyrene, dimethylstyrene, chlorostryene, dichlorostyrene, tert-butylstyrene, bromostyrene, and p-chloromethylstyrene), monofunctional acrylic esters (e.g., methyl acrylate, ethyl acrylate, isopropyl acrylate, n-butyl acrylate, butoxyethyl acrylate, isobutyl acrylate, n-amyl acrylate, isoamyl acrylate, n-hexyl acrylate, octyl acrylate, decyl acrylate, dodecyl acrylate, octadecyl acrylate, benzyl acrylate, phenyl acrylate, phenoxyethyl acrylate, cyclohexyl acrylate, dicyclopentanyl acrylate, dicyclopentenyl acrylate, dicyclopentenyloxyethyl acrylate, tetrahydrofurfuryl acrylate, isobornyl acrylate, isoamyl acrylate, lauryl acrylate, stearyl acrylate, benhenyl acrylate, ethoxydiethylene glycol acrylate, methoxytriethylene glycol acrylate, methoxydipropylene glycol acrylate, phenoxypolyethylene glycol acrylate, nonylphenol EO adduct acrylate, isooctyl acrylate, isomyristyl acrylate, isostearyl acrylate, 2-ethylhexyl diglycol acrylate, and oxtoxypolyethylene glycol polypropylene glycol monoacrylate), monofunctional methacrylic esters (e.g., methyl methacrylate, ethyl methacrylate, isopropyl methacrylate, n-butyl methacrylate, i-butyl methacrylate, tert-butyl methacrylate, n-amyl methacrylate, isoamyl methacrylate, n-hexyl methacrylate, 2-ethylhexyl methacrylate, lauryl methacrylate, tridecyl methacrylate, stearyl methacrylate, isodecyl methacrylate, octyl methacrylate, decyl methacrylate, dodecyl methacrylate, octadecyl methacrylate, methoxydiethylene glycol methacrylate, polypropylene glycol monomethacrylate, benzyl methacrylate, phenyl methacrylate, phenoxyethyl methacrylate, cyclohexyl methacrylate, tetrahydrofurfuryl methacrylate, tert-butylcyclohexyl methacrylate, behenyl methacrylate, dicyclopentanyl methacrylate, dicyclopentenyloxyethyl methacrylate, and polypropylene glycol monomethacrylate), allyl compounds (e.g., allylbenzene, allyl-3-cyclohexane propionate, 1-allyl-3,4-dimethoxybenzene, allyl phenoxyacetate, allyl phenylacetate, allylcyclohexane, and allyl polyvalent carboxylate), unsaturated esters of fumaric acid, maleic acid, itaconic acid, etc., and radical polymerizable group-containing monomers (e.g., N-substituted maleimide and cyclic olefins). Non-limiting examples of suitable hydrophobic prepolymers include low molecular weight (e.g., where the molecular weight is less than 1000 and the viscosity is less than 300 cP) acrylic oligomers, such as, e.g., polyethylene-co-acrylic acid, polystyrene-co-polyhexylacrylate, and polyethylene-co-methacrylic acid.

In still another example, the hydrocarbon may be selected from those that are halogenated, or include a ketone, or combinations thereof. Some non-limiting examples of hydrocarbons that are halogenated include fluorocarbons, such as TEFLON® (Dupont, Midland Mich.) and chlorinated polymers, such as polyvinyl chloride (PVC). A non-limiting example of a hydrocarbon including a ketone includes a polyacrylate. Some non-limiting examples of hydrocarbons that are both halogenated and include ketone(s) include alkyl chloroacrylates (e.g., methyl-2-chloroacrylate and ethyl-2-chloroacrylate) and ethyl-chloroacetate.

The carrier may, in some embodiments, include a single hydrocarbon selected from any of the hydrocarbons identified above. In other embodiments, however, the carrier may include combinations of two or more of the above-identified hydrocarbons. In an embodiment, the carrier may include a combination of a halogenated hydrocarbon and an oil, a mixture of various linseed oils, or a mixture of linseed oil and any other hydrocarbon(s) listed herein.

Additionally, the hydrocarbon alone typically constitutes the medium of the carrier. In some cases, it may be desirable to add other non-reacting oil-based components to the carrier. Non-limiting examples of the non-reacting oil-based components include aliphatic hydrocarbons, such as hexanes, heptanes, hexadodecane, and ISOPAR™ isoparaffinic fluids (Exxon Mobile, Houston, Tex.). When these non-reacting oil-based components are added, they may be present in an amount ranging from 0.5 wt % to 5.0 wt % of the total weight of the composition.

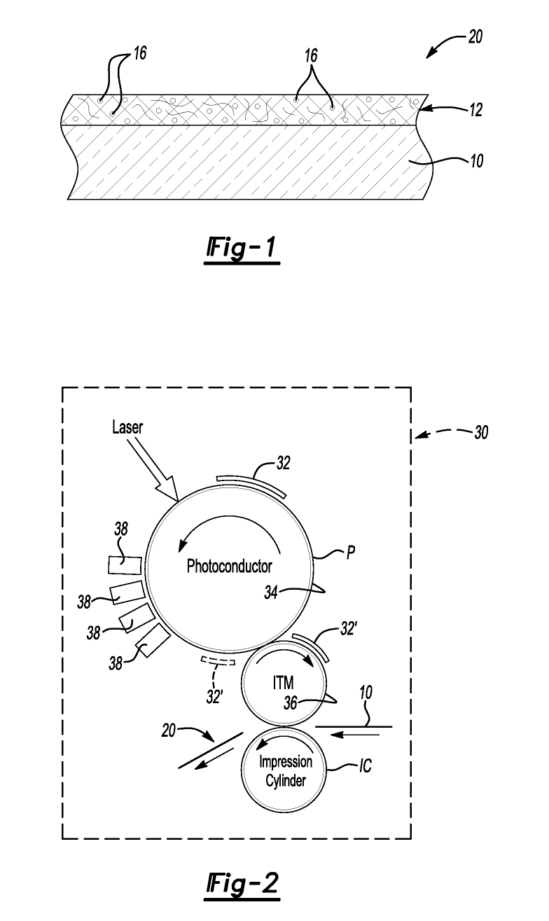

Referring now to FIG. 1, a print 20 formed using an embodiment of the composition is depicted. The print 20 includes the composition (e.g., carrier, or carrier and colorant, or carrier, colorant and dispersant) printed on a substrate 10. The substrate 10 may be selected from any porous or non-porous substrates. Some non-limiting examples of non-porous substrates include elastomeric materials (e.g., polydimethylsiloxane (PDMS)), semi-conductive materials (e.g., indium tin oxide (ITO) coated glass), dielectric materials, flexible materials (e.g., polycarbonate films, polyethylene films, polyimide films, polyester films, and polyacrylate films). Non-limiting examples of porous substrates include coated or uncoated paper.

During the printing process, the hydrocarbon in the composition is polymerized and/or crosslinked to form a thin hydrocarbon polymer matrix 12 that is ultimately transferred to the substrate 10. More specifically, the polymerizing and/or crosslinking of the hydrocarbon polymer precursor forms a substantially continuous hydrocarbon polymer matrix. In an example, when pigments are included in the composition and the polymer coverage extends over a length or diameter of at least 100 μm, the hydrocarbon polymer matrix 12 is considered to be a thin film, whereas when no colorants (i.e., no pigments or dyes) are included and the polymer coverage extends over a length or diameter of at least 100 μm, the polymer matrix 12 is considered to be a thin layer. It is to be understood, however, that compositions including i) a mixture of a dye and a pigment, and/or ii) a dye and a polymer(s) may, in some cases, result in a thin film. As previously mentioned, the polymer matrix 12 may also be printed in any suitable pattern, including dots, lines, etc.

The polymer matrix 12 sufficiently adheres to the substrate 10 surface such that additional adhesive materials are not required in the composition. In fact, the composition is substantially immediately fixed to the substrate 10 upon being transferred thereto, and thus desirable page attributes (such as scratch and rub resistance) may be achieved when printing on both porous and non-porous substrates 10. It is to be understood that the transfer of the polymer matrix 12 to the substrate 10 will be described further herein in reference to FIGS. 2 and 3.

While, as previously mentioned, the composition may include the carrier alone, it is to be understood that the composition may also include a colorant, and in some instances a dispersant, dispersed (or mixed in the case of a solid) in the hydrocarbon. In FIG. 1, the colorant (such as pigment particles 16) present in the original composition becomes embedded and/or entrapped in the resulting polymer matrix 12 of the polymerized and/or crosslinked hydrocarbon. The immobilized colorants 16 will thus be retained on the substrate 10 surface (i.e., do not penetrate into the substrate 10), which advantageously improves the print quality of the digital image on the print 20.

In instances where the printing composition is an ink or a toner, the printing composition further includes the colorant. As used herein, the term “colorant” refers to i) one or more pigments, ii) one or more dyes, or iii) combinations of pigment(s) and dye(s). In two non-limiting examples, the colorant may be selected from pigment particles that are self-dispersible in the carrier, or a combination of the self-dispersing pigment and a dye. In these examples, the printing composition includes the carrier and the pigment, or the carrier and the pigment and the dye alone (i.e., without additional components). In two other non-limiting examples, the colorant may be selected from pigment particles that are non-self-dispersible in the carrier, or a combination of the non-self-dispersing pigment and a dye. In the later examples, the printing composition includes one or more dispersants in addition to the carrier and the pigment, or the carrier and the pigment and the dye. In yet another non-limiting example, the colorant is selected from a dye alone. In these examples, the printing composition includes the carrier and the dye, without pigments and without dispersants.

The compositions disclosed herein may include 1 wt. % to 100 wt. % non-volatile solids (e.g., 100 wt. % includes when the carrier is a solid). When the colorant is included, it can be made up from about 1.5 wt. % to about 50 wt. % of the total non-volatile solids.

When utilized, the dispersant is selected so that it is at least partially soluble in the selected carrier. For example, in instances where the carrier is an oil-based hydrocarbon (e.g., unsaturated fatty acids, glycerides, etc.), the dispersant may be selected from dispersants that are at least partially soluble in the oil-based hydrocarbon. The dispersants may be selected from anionic dispersants, cationic dispersants, amphoteric dispersants, non-ionic dispersants, polymeric dispersants, oligomeric dispersants, crosslinking dispersants, or combinations thereof. Examples of anionic dispersants include sulfosuccinic acid and derivatives thereof such as, for instance, alkyl sulfosuccinates (e.g., GEROPON® SBFA-30 and GEROPON® SSO-75, both of which are manufactured by Rhodia, Boulogne-Billancourt, France) and docusate sodium. Examples of cationic dispersants include quaternary amine polymers, protonated amine polymers, or polymers containing aluminum (such as those that are available from Lubrizol Corp., Wickliffe, Ohio). Further examples of cationic dispersants include SOLSPERSE® 19000 (Lubrizol Corp.) and other like cationic dispersants. Amphoteric dispersants include those that contain compounds having protonizable groups and/or ionizable acid groups. A non-limiting example of a suitable amphoteric dispersant includes lecithin. Examples of non-ionic dispersants include, but are not limited to oil-soluble polyesters, polyamines, polyacrylates, polymethacrylates (such as, e.g., SOLSPERSE® 3000 (Lubrizol Corp.), SOLSPERSE® 21000 (Lubrizol Corp.), or the like). Non-limiting examples of oligomeric dispersants include low average molecular weight (i.e., less than 1000) non-ionic dispersants. Examples of cross-linking dispersants include, but are not limited to, polymers or oligomers containing two or more carbon double bonds (C═C) and free amine groups such as, e.g., polyamines, crosslinkable polyurethanes, and divinyl benzene.

When a dispersant is used, such dispersant may be included in an amount ranging from about 2 wt. % to about 100 wt. % of the total non-volatile solids present. In one non-limiting example, the dispersant is present in an amount of about 10 wt. %.

In the embodiments where the colorant is or includes a pigment, the pigment may be selected from organic pigments or inorganic pigments particles, and these particles may have any particle size that allows the composition including the pigment to be printed from the digital printer. In an example, the particle size of the pigments range from about 1 nm to about 10 μm. In another example, the particle size of the pigments range from about 100 nm to about 300 nm. In still another example, particle size ranges from about 1 μm to about 20 μm. Organic or inorganic pigment particles may be selected from, but are not limited to, black pigment particles, yellow pigment particles, magenta pigment particles, red pigment particles, cyan pigment particles, blue pigment particles, green pigment particles, orange pigment particles, brown pigment particles, and white pigment particles. In some instances, the organic or inorganic pigment particles may include spot-color or specialty pigment particles. Spot-color pigments are formed from a combination of a predefined ratio of two or more primary color pigment particles. Specialty pigments may, e.g., be metallic, fluorescent and/or opalescent pigments.

A non-limiting example of a suitable inorganic black pigment includes carbon black. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, the MOGUL® series, or the MONARCH® series manufactured by Cabot Corporation, Boston, Mass., (such as, e.g., REGAL® 400R, REGAL® 330R, and REGAL® 660R); and various black pigments manufactured by Evonik Degussa Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® U, PRINTEX® V, PRINTEX® 140U, Special Black 5, Special Black 4A, and Special Black 4). A non-limiting example of an organic black pigment includes aniline black, such as C.I. Pigment Black 1.

Some non-limiting examples of suitable yellow pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 167, C.I. Pigment Yellow 172, C.I. Pigment Yellow 180, and C.I. Pigment Yellow 185.

Non-limiting examples of suitable magenta or red organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50.

Non-limiting examples of blue or cyan organic pigments include C.I. Pigment Blue 1, C.I. Pigment Blue 2, C.I. Pigment Blue 3, C.I. Pigment Blue 15, C.I. Pigment Blue 15:3, C.I. Pigment Blue 15:34, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Non-limiting examples of green organic pigments include C.I. Pigment Green 1, C.I. Pigment Green 2, C.I. Pigment Green, 4, C.I. Pigment Green 7, C.I. Pigment Green 8, C.I. Pigment Green 10, C.I. Pigment Green 36, and C.I. Pigment Green 45.

Non-limiting examples of brown organic pigments include C.I. Pigment Brown 1, C.I. Pigment Brown 5, C.I. Pigment Brown 22, C.I. Pigment Brown 23, C.I. Pigment Brown 25, and C.I. Pigment Brown, C.I. Pigment Brown 41, and C.I. Pigment Brown 42.

Non-limiting examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, and C.I. Pigment Orange 66.

In another embodiment, the pigment may be selected from metallic pigments, where the metallic pigments also have a particle size enabling the composition to be printed from the digital printer. In an example, the particle size of the metallic pigment ranges from about 0.1 μm to about 20 μm. Suitable metallic pigments include, but are not limited to, a metal selected from gold, silver, platinum, nickel, chromium, tin, zinc, indium, titanium, copper, aluminum, and alloys of any of these metals. These metals may be used alone or in combinations with two or more metals or metal alloys. Non-limiting examples of metallic pigments include Standard RO100, Standard RO200, and DORADO PX™ 4001 (available from Eckart Effect Pigments, Wesel, Germany).

In yet another embodiment, the pigment may be selected from a pearlescent pigment (also known as an opalescent pigment), where the pearlescent pigments have a particle size that enable the composition to be printed from the digital printer. In an example, the pearlescent particle size ranges from about 0.1 μm to about 20 μm. It is to be understood that suitable pearlescent pigments are those that tend to exhibit various colors depending on the angle of illumination and/or of viewing. Non-limiting examples of pearlescent pigments include those of the PRESTIGE® series and of the DORADO PX™ series, both of which are available from Eckart Effect Pigments.

Some non-limiting examples of dyes that may be used as the colorant or one of many colorants include fluorescein, rhodamine, nigrosine, and napthol green.

For inks and toners, the printing composition may be formed by dispersing the colorant (and, in some instances, the dispersant) in the liquid carrier. Dispersing the colorant (and, in some instances, the dispersant) may be accomplished using any suitable apparatus, non-limiting examples of which include a microfluidizer, mills, and ultrasonicators. In instances where a solid carrier is used, the carrier is heated to the melting point of the solid, and then the colorants are incorporated into the melt. Incorporation of the colorants into the melt may be accomplished, for example, by stirring and/or mixing, and then allowing the melt to cool and re-solidify.

In instances where the printing composition is a fixer, the composition is prepared by selecting the hydrocarbon for the carrier. If more than one hydrocarbon is selected for the carrier, the hydrocarbons are mixed together in a desirable ratio. As non-limiting examples, ISOPAR™ L is mixed with ISOPAR™ V in a ratio of 80:20, or linseed oil is mixed with ISOPAR™ L in a ratio of 90:10.

In any of the embodiments disclosed herein, polymeriziation and/or crosslinking may be further controlled by incorporating a catalyst (such as, e.g., triethylaluminium (TEA), methylaluminoxane (MAO), etc.) in the composition, and then activating the catalyst upon corona discharge. The catalyst may be incorporated in order to facilitate crosslinking/polymerization from within the printed ink composition, for example, in areas that may not easily be reached by the reactive species.

The compositions disclosed herein undergo crosslinking and/or polymerization when exposed to corona discharge for a brief time period (e.g., 1 minute or less). In order to decrease the corona discharge exposure time needed to initiate crosslinking and/or polymerization, the compositions disclosed herein may also include drying agents (i.e., dryers). Non-limiting examples of suitable dryers are fatty acid salt complexes derived from cobalt, manganese, or iron, with zirconium, lead, or calcium salts of fatty acids; such as, for example, 2-ethylhexanoic acid (e.g., cobalt (II) 2-ethylhexanoate and manganese bis-2-ethylhexanoate) and naphthenic acid (e.g., cobalt (II) naphthenate and ferric naphthenate). The drying agent(s) may be present in an amount ranging from about 0.1 wt. % to about 5 wt. %. In one non-limiting example, the drying agent is included in an amount ranging from about 0.5 wt. % to about 1 wt. %.

Also disclosed herein is an ink set for digital printing systems, where the ink set includes two or more inks, each of which has a different color or a different shade of the same color, or where one of the inks is colorless and the other of the inks has a color. For instance, the ink set may include a black ink, a cyan ink, a yellow ink, and a magenta ink, or a magenta ink and a light magenta ink. In some examples, the ink set further includes a fixer fluid (i.e., the colorless carrier). Each of the inks and the fixer fluid of the ink set are formulated according to the embodiments disclosed herein.

Referring now to FIGS. 1 and 2 together, the printing composition may be printed from a digital printer or printing system 30 such as, e.g., an electrophotographic printer. In the embodiments disclosed herein, the electrophotographic printing system 30 includes at least two corona generators 32, 32′. It is to be understood that the corona generators 32, 32′ generally have a relatively high electric field, where such electric fields are used by the digital printing system 30 for image development and formation of the polymer matrix 12. In a non-limiting example, the electric charge or field of the corona discharge ranges from about 1 kV to about 5 kV with a current ranging from about 1 μA to about 1000 μA. The current may be convective current, which facilitates improved mixing in the final polymer matrix 12. Improved mixing is particularly desirable when colorants are included in the composition, at least in part because the print quality and durability of the resulting print 20 is enhanced.

Without being bound to any theory, it is believed that when each corona generator 32, 32′ discharges, it forms a high energy species (such as, e.g., radicals, ions, etc.). Depending upon the position of the generator 32, 32′ (e.g., when the wire(s) are positioned parallel to the surface to be exposed and are equal to or less than 10 mm apart from the surface to be exposed), the high energy species can create a uniform charge layer on the surface 34 of a photoconductor, or can react with unsaturated species (e.g., the hydrocarbons) in a deposited ink composition to cause crosslinking of the unsaturated species. In the latter example, if the high energy species can propagate through the deposited composition, polymerization takes place in addition to crosslinking. As such, instead of adding a radical initiator (e.g., AIBN) into the composition, an additional corona generator 32′ is included in the system 30 to generate the high energy species in an area where the species can initiate crosslinking, and possibly polymerization, of the hydrocarbon present in the composition. The high energy species react with the surface of the deposited composition and crosslink from the top down, and/or propagate through the deposited composition causing polymerization.

In an example, the charged species used to polymerize and/or crosslink the hydrocarbon includes any molecular species having an electrical charge, such as, e.g., radicals, radical ions, carbenes, cations, anions, peroxides, acids, and bases. Some non-limiting examples of radicals and radical ions include oxy-radicals, hydroxyl radicals, nitroxide radicals, polycyclic aromatic hydrocarbon radicals, and respective ions of the previously listed radicals. Non-limiting examples of carbenes include those that may be generated photolytically from diazirines, epoxides, and halogenated hydrocarbons, such as chloroform. Examples of cations include, but are not limited to, any compound having a net positive charge, such as ammonium, carbonium, phosphonium, and hydronium. Examples of anions include, but are not limited to, any compound having a net negative charge, such as hydroxides, sulfides, hydrides, and deprotonated amines. Non-limiting examples of acids and bases include any compound having hydrogen bound to non-carbon atoms, or Lewis acids and bases. Examples of acids having hydrogen bound to non-carbon atoms include organic and inorganic acids such as sulfuric acid, phosphoric acid, hydrochloric acid, nitric acid, phenol, fatty acids, benzolic acid, and acetic acid. Examples of bases having hydrogen bound to non-carbon atoms include amines, sulfides, and hydroxyls. Examples of Lewis acids include molecules capable of accepting electrons, such as those that include metal halides (e.g., aluminum chloride, boron trifluoride, phosphorus pentachloride, and boron trifluoride). Examples of Lewis bases includes molecules that can donate electrons to Lewis acids, such as compounds containing nitrogen, phosphorus, arsenic, antimony, and/or bismuth in oxidation state 3 or compounds containing oxygen, sulfur, selenium, and/or tellurium in oxidation state 2. Specific examples of Lewis bases include water, ethers, ketones, sulfoxides, and carbon monoxide. Non-limiting examples of peroxides include benzoyl peroxide and hydroperoxide.

The charged species may be produced, for example, during corona discharge of the corona generators 32, 32′ that are operatively disposed in the digital printing system 30. Each of the corona generators 32, 32′ described herein includes a power supply that is capable of supplying high voltage power to a conductor, such as a discharge electrode. The discharge electrode ionizes the atmosphere or gases surrounding the discharge electrode, thereby forming a reactive species that reacts with the printing composition. As such, the term “corona discharge” refers to an electrical discharge brought on by the ionization of the atmosphere or gases surrounding a conductor, which occurs when the potential gradient (the strength of the electric field) exceeds a certain value, but conditions are insufficient to cause complete electrical breakdown or arcing. The corona generator(s) 32, 32′ may include insulation to prevent against electrical shocks, and a ground plate to ground the generator(s).

In the example shown in FIG. 2, the printing system 30 includes a photoconductor P that is configured to rotate in a first direction (as denoted by the left pointing arrow in the photoconductor P). The photoconductor P has a surface 34 that may be exposed to various elements of the system 30 when the photoconductor P is rotated.

A first corona generator 32 (such as, e.g., a printer wire or an array of printer wires configured to generate corona discharge) is operatively positioned adjacent to a portion of the surface 34 of the photoconductor P. When the system 30 is in operation, the corona discharge from corona generator 32 generates a charge on the portion of the photoconductor surface 34 exposed to such discharge. It is to be understood that the photoconductor P rotates to develop a uniform layer of charge on the surface 34. As previously described, the charge may be positive or negative, depending upon the type of corona generator 32 used.

The system 30 also includes a laser (labeled “LASER” in FIG. 2) that is positioned adjacent to the photoconductor surface 34. Generally, the laser is positioned such that as the photoconductor P rotates in the first direction, some of the areas of the surface 34 exposed to the corona discharge from the generator 32 are exposed to the emission from the laser. The laser is selected so that its emission can generate charges opposite to those already present on the surface 34 from within the photoconductor 34. By virtue of creating opposite charges, the laser effectively neutralizes the previously formed charges at areas exposed to the laser emission. This neutralization forms a latent image. It is to be understood that those areas of the surface 34 not exposed to the laser remain charged.

A processor (not shown) operatively connected to the laser commands the laser to form the latent image so that the remaining charged portions of the surface 34 can be used to generate the desirable digital image. The processor is capable of running suitable software routines or programs for receiving desirable digital images, and generating commands for the generator(s) 32, 32′, 32″, 32′″, the cartridges 38, and the various components P, ITM, IC, etc. to reproduce the digital images using the system 30.

The system 30 further includes at least one ink reservoir/cartridge 38 containing an embodiment of the composition disclosed herein (i.e., includes the hydrocarbon carrier). In one embodiment, the inks are selected to carry a charge that is opposite to that of the uniform layer of charge on the surface 34. The ink reservoir(s)/cartridge(s) 38 include ejectors or printheads and are also operatively positioned to deposit the ink(s) onto the remaining charged portion(s) of the surface 34 to form an ink layer on the surface of the photoconductor 34. It is to be understood that the charges remaining on the surface 34 after exposure to the laser will attract the oppositely charged ink(s).

Additionally or alternatively, it is to be understood that electrically neutral carrier(s) (i.e., inks without colorants) can be deposited on the discharged (i.e., neutralized) regions or the remaining charged regions of the surface 34, so that cross-linking/polymerization results in the formation of a continuous image (e.g., a polymer matrix 12 including colored and colorless areas) that is transferred to the substrate 10. Likewise, charged ink can be transferred from cartridge(s) 38 onto the discharged (i.e., neutralized) regions on the surface 34 by applying an appropriate potential bias between the cartridges 38 and the surface 34.

As illustrated in FIG. 2, the system 30 further includes a second corona generator 32′ positioned adjacent to either the photoconductor P or an intermediate transfer medium ITM (which rotates in a second direction that is opposite to direction of rotation of the photoconductor P). It is to be understood that the ITM is grounded or positively bias with respect to the photoconductor P.

When positioned adjacent to the photoconductor P, it is to be understood that this second generator 32′ produces a charged species that is exposed to the ink layer while the layer is still positioned on the surface of the photoconductor 34. In this embodiment, the second generator 32′ is positioned between the ink reservoirs/cartridges 38 and the ITM. The corona discharge from this embodiment of the second generator 32′ initiates at least one of polymerization or crosslinking of the hydrocarbon in the ink layer to form the polymer matrix 12 on the surface of the photoconductor P. As the photoconductor P continues to rotate, the polymer matrix 12 is transferred to the intermediate transfer medium ITM. As illustrated in FIG. 2, the system 30 further includes an impression cylinder IC that is rotatable in the first direction. The impression cylinder IC guides the substrate 10 such that a surface of the substrate 10 contacts the polymer matrix 12 on the rotating intermediate transfer medium ITM. When in contact, the polymer matrix 12 transfers to the substrate 10.

When positioned adjacent to the intermediate transfer medium ITM, it is to be understood that the second generator 32′ produces a charged species that is exposed to the ink layer after such layer has been transferred from the surface of the photoconductor 34 to the surface of the ITM. In this embodiment, the second generator 32′ is positioned adjacent to the surface 36 of the ITM at an area beyond where the ink layer transfer takes place. The corona discharge from this embodiment of the second generator 32′ initiates at least one of polymerization or crosslinking of the hydrocarbon in the ink layer to form the polymer matrix 12 on the surface 36 of the ITM. As the intermediate transfer medium ITM continues to rotate, the polymer matrix 12 is transferred to the substrate 10 guided by the impression cylinder IC that is rotatable in the first direction (i.e., opposite to the rotation of the ITM). The impression cylinder IC guides the substrate 10 such that a surface of the substrate 10 contacts the polymer matrix 12 on the rotating intermediate transfer medium ITM. When in contact, the polymer matrix 12 transfers to the substrate 10.

While not shown, it is to be understood that the system 30 also includes a charge neutralization unit positioned after the ITM and adjacent to the surface 34 of the photoconductor P. The charge neutralization unit neutralizes any opposite charges remaining on the surface 34 of the photoconductor P prior to the next cycle of printing.

It is to be understood that the compositions disclosed herein may also be used in digital inkjet printing systems. In such instances, neither the first corona generator 32 nor the laser is utilized. The ink reservoirs/cartridges 38 (operatively attached to inkjet thermal or piezoelectric printheads) are positioned to print the ink composition directly onto the photoconductor P, the ITM (e.g., a dielectric drum), or on the substrate 10, and one or more of the corona generator(s) 32′, 32″, 32′″ are operatively positioned downstream of where the ink composition is printed to generate the charged species to initiate crosslinking and/or polymerization of the printed ink composition. In instances where printing and crosslinking occurs directly on the substrate 10, the photoconductor, the laser and the ITM are omitted from the system.

To reiterate from above, the polymerizing and/or crosslinking initiated by the second corona generator 32′ forms the thin hydrocarbon-based matrix 12, which is ultimately transferred to the substrate 10 surface (shown in FIG. 1). In an example, the thin matrix 12 has a thickness ranging from about 10 nm to about 10 μm. Again, the hydrocarbon matrix 12 (if formed from an ink or a toner) may include the colorant 16 (which may be a pigment and/or a dye) embedded in the matrix 12 of the polymerized and/or crosslinked hydrocarbon as schematically shown in FIG. 1.

Referring now to FIG. 3, another embodiment of the electrophotographic system 30′ is depicted. This system 30′ is similar to the system 30 shown in FIG. 2, except that additional corona generators 32, 32′, 32″, 32′″ are included. In this embodiment, the first generator 32 creates the uniform charge surface, and the second generator 32′ initiates crosslinking and/or polymerization of the ink layer while it is on the surface 34 of the photoconductor P.

It is believed that the third corona generator 32″ may be used to improve the efficiency of the crosslinking and/or polymerization. In this embodiment, the third generator 32″ is positioned adjacent to the intermediate transfer medium ITM. In some instances, after exposure to the corona discharge from the second generator 32′, crosslinking and/or polymerization of the hydrocarbons in the polymer matrix 12 may not be complete upon transfer of the polymer matrix 12 to the ITM. The third generator 32″ produces yet another charged species that is exposed to the polymer matrix 12 after the layer has been transferred from the surface of the photoconductor 34 to the surface of the ITM. In one non-limiting example, about 80% of the hydrocarbons are crosslinked and/or polymerized after exposure to the charged species from generator 32′, and exposure to the charged species from the generator 32″ may increase the percentage of crosslinked and/or polymerized hydrocarbons in the polymer matrix 12. In this embodiment, the third generator 32″ is positioned adjacent to the surface 36 of the ITM at an area beyond where the polymer matrix 12 transfer takes place. As previously mentioned, the corona discharge from the third generator 32″ is believed to enhance the polymerization or crosslinking, by exposing any remaining unreacted hydrocarbons in the polymer matrix 12 to complete formation of the polymer matrix 12 on the surface 36 of the ITM.

As the intermediate transfer medium ITM continues to rotate, the polymer matrix 12 is transferred to the substrate 10 guided by the impression cylinder IC that is rotatable in the first direction (i.e., opposite to the rotation of the ITM). The impression cylinder IC guides the substrate 10 such that a surface of the substrate 10 contacts the polymer matrix 12 on the rotating intermediate transfer medium ITM. When in contact, the polymer matrix 12 transfers to the substrate 10. As illustrated in FIG. 3, the system 30′ may also include a fourth corona generator 32′″. This generator 32′″ may be positioned adjacent to the impression cylinder IC at an area where the polymer matrix 12 has been transferred to the substrate 10. This generator 32′″ produces yet another charged species that aids in fixing the polymer matrix 12 to the substrate 10.

While not shown in FIG. 3, it is to be understood that the system 30′ also includes a charge neutralization unit positioned after the ITM and adjacent to the surface 34 of the photoconductor P. The charge neutralization unit neutralizes any opposite charges remaining on the surface 34 of the photoconductor P prior to the next cycle of printing.

In any of the embodiments disclosed herein, the transfer of the polymer matrix 12 to the substrate 10 may be aided via pressure transfer or by tailoring the glass transition temperature (Tg) of the polymer matrix 12 to be from about 50° C. to about 120° C. Tailoring the Tg may be accomplished by selecting the hydrocarbon polymer precursors so that the resulting polymer matrix 12 incorporates both low and high temperature melting or softening polymers. In an example, low melting temperature polymers include those that melt or soften (e.g., have a Vicat softening point) at temperatures ranging from about room temperature (e.g., 20° C.) to 80° C., and high melting temperature polymers include those that melt or soften at temperatures that are greater than 80° C. Alternatively, tailoring the Tg may be accomplished by adding oligomers to the hydrocarbon polymer precursors. Examples of suitable oligomers include those having more than three, but less than ten repeating units. For instance, the oligomer may be a short chain version of an acrylic acid, such as an acrylic acid having five repeating units (rendering the acrylic acid as a oligomer) instead of, e.g., twenty or more repeating units (rendering the acrylic acid as a polymer). When the Tg is tailored, internal or external heating at the ITM may be used to create a tacky polymer matrix 12 to aid in the transfer of the polymer matrix 12 to the substrate 10.

To further illustrate embodiment(s) of the present disclosure, the following Example is given herein. It is to be understood that this Example is provided for illustrative purposes and is not to be construed as limiting the scope of the disclosed embodiment(s).

### EXAMPLE

A sample ink was prepared by dispersing 5 wt % of a cyan pigment in Linseed oil (available from Cargill, Inc., Minnetonka, Minn.) with 0.5 wt % of SP 13940 dispersant in a M-110Y microfluidizer for about 40 minutes. The ink was smeared onto an indium tin oxide (ITO)-glass substrate and was exposed to corona discharge of 3.5 kV at a current of about 90 μA for about 1 minute to form a layer of the polymerized ink on the ITO-glass. The ink sample was thereafter rinsed with a solvent to remove the ink that was not exposed to the corona discharge. The substrate having the layer formed thereon (after ink removal) is shown in FIG. 4, and is referred to herein as the media sample.

A comparative ink sample was also prepared, where the comparative sample included a cyan pigment suspended in ISOPAR™ L (i.e., not one of the carriers disclosed herein). The comparative ink sample was exposed to corona discharge. More specifically, the formulation of the comparative sample was prepared by mixing 5 wt % of cyan pigment in ISOPAR™ L with 1 wt % of SOLSPERSE® 13940 dispersant in a M-100Y microfluidizer for about 30 minutes. This comparative ink sample was smeared onto an indium tin oxide (ITO)-glass substrate was exposed to corona discharge in the same manner as the media sample. This sample is referred to herein as the comparative media sample.

The media sample and the comparative media sample were both exposed to a number of dry rub and highlighter smear tests. The dry rub test was performed using a TABER® Linear Abraser Model 5750. The arm of the linear abraser stroked each media and comparative media sample in a linear motion back and forth at a controlled stroke speed (2 cm/sec) and length (2 cm), and the head of the linear abraser followed the contours of the media and comparative media samples. A 250 g weight was added to the shaft of the linear abraser to generate a constant load.

For the dry rub test, a stroking head (also referred to as a “wearaser”) was attached to the end of the arm of the linear abraser. The stroking head was about the size and shape of a pencil eraser, and had a contact patch with a diameter of about 0.25 inches. A CALIBRASE® CS-10 was used to make the stroking head abrasive with a mild to medium abrasive effect. The stroking head was then stroked back and forth 10 times on each sample. The rubbed media and comparative media samples were thereafter evaluated for color fastness.

The same procedure described above for the dry rub test was also performed for the highlighter smear test, however a highlighter pen was used in place of the linear abraser.

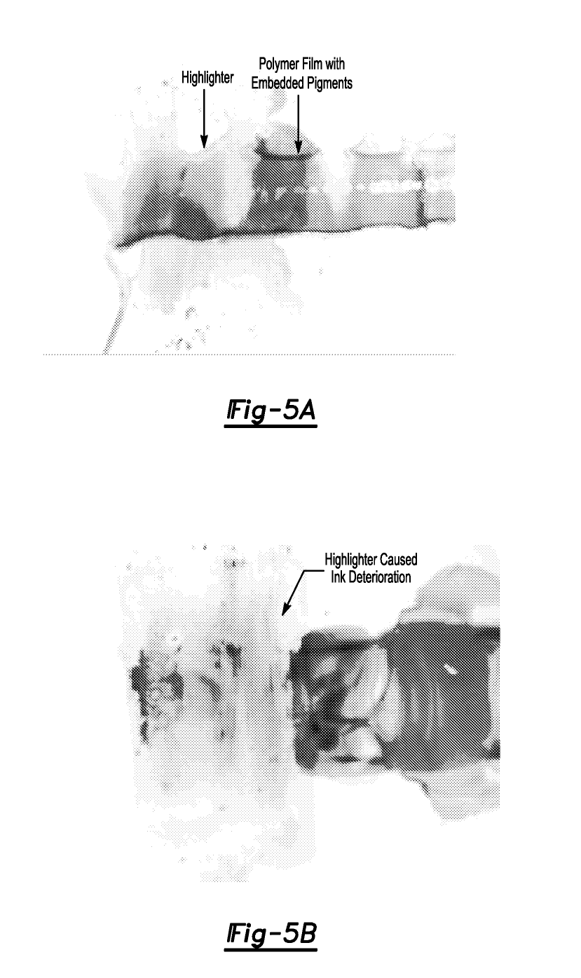

As shown in FIGS. 5A and 5B, the comparative media sample (FIG. 5B) showed i) an absence of film formation on the ITO-glass substrate, and ii) a significant amount of smearing for both rub and highlighter smear tests when compared to the sample (FIG. 5A).

It is to be understood that the ranges provided herein include the stated range and any value or sub-range within the stated range. For example, an amount ranging from approximately 1 wt % to about 20 wt % should be interpreted to include not only the explicitly recited amount limits of 1 wt % to about 20 wt %, but also to include individual amounts, such as 2 wt %, 3 wt %, 4 wt %, etc., and sub-ranges, such as 5 wt % to 15 wt %, 10 wt % to 20 wt %, etc.

While several embodiments have been described in detail, it will be apparent to those skilled in the art that the disclosed embodiments may be modified. Therefore, the foregoing description is to be considered exemplary rather than limiting.

1. A digital printing composition, comprising:
a carrier, including a hydrocarbon having at least one unsaturated bond, the hydrocarbon being configured to at least one of polymerize or crosslink in the presence of a charged species produced from a corona generator; and
a colorant.

2. The digital printing composition as defined in claim 1 wherein the colorant is dispersed in the carrier and is selected from a dye, a pigment, or combinations thereof

3. The digital printing composition as defined in claim 2 wherein the colorant is a pigment, and wherein the digital printing composition further comprises a dispersant that is at least partially soluble in an oil, the dispersant being selected from anionic dispersants, cationic dispersants, amphoteric dispersants, non-ionic dispersants, polymeric dispersants, oligomeric dispersants, crosslinking dispersants, or combinations thereof.

4. The digital printing composition as defined in claim 2 wherein the pigment is selected from organic pigments, inorganic pigments, metallic pigments, or opalescent pigments.

5. The digital printing composition as defined in claim 1 wherein the colorant is a pigment, a dye, or combinations thereof, and wherein the colorant is configured to be embedded in a polymer matrix of the at least one of the polymerized or crosslinked hydrocarbon.

6. The digital printing composition as defined in claim 1 wherein the at least one unsaturated bond of the hydrocarbon is conjugated, and wherein the at least one unsaturated bond is selected from a diene, an enone, or a terminal olefin.

7. The digital printing composition as defined in claim 1 wherein the hydrocarbon is selected from an oil including an unsaturated fatty acid, a glyceride, or combinations thereof.

8. The digital printing composition as defined in claim 1 wherein the hydrocarbon is halogenated, or includes a ketone, or combinations thereof.

9. The digital printing composition as defined in claim 1 wherein the charged species is selected from radicals, radical ions, carbenes, cations, anions, peroxides, acids, or bases.

10. A carrier for a digital printing composition, comprising:
a hydrocarbon having at least one unsaturated bond, the hydrocarbon being configured to polymerize or crosslink in the presence of a charged species produced from a corona generator in a time period of 1 minute or less; and
a drying agent selected from fatty acid salt complexes derived from Co, Mn, or Fe, with Zr, Pb, or Ca salts of fatty acids.

11. The carrier as defined in claim 10 wherein the at least one unsaturated bond of the hydrocarbon is conjugated, the conjugated bond being selected from a diene, an enone, or a terminal olefin.

12. The carrier as defined in claims 10 wherein the hydrocarbon is selected from an oil including an unsaturated fatty acid, a glyceride, or combinations thereof.

13. The carrier as defined in claim 10 wherein the hydrocarbon is halogenated, includes a ketone, or combinations thereof.

14. An ink set, comprising:
at least two inks, each of which includes:
a carrier including a hydrocarbon having at least one unsaturated bond, the hydrocarbon being configured to at least one of polymerize or crosslink in the presence of a charged species produced from a corona generator; and
a colorant; and
a fixer fluid including an other hydrocarbon having at least one unsaturated bond, the other hydrocarbon being configured to at least one of polymerize or crosslink in the presence of an other charged species produced from corona discharge.

15. The ink set as defined in claim 14 wherein the hydrocarbon and other hydrocarbon are individually selected from:
i) hydrocarbons having the at least one conjugated unsaturated bond selected from a diene, an enone, or a terminal olefin;
ii) an oil including an unsaturated fatty acid, a glyceride, or combinations thereof; or
iii) halogenated hydrocarbons, hydrocarbons including a ketone, or combinations thereof.

16. The digital printing composition as defined in claim 3 wherein the pigment is selected from organic pigments, inorganic pigments, metallic pigments, or opalescent pigments.

17. The digital printing composition as defined in claim 3 wherein:
i) the at least one unsaturated bond of the hydrocarbon is conjugated, and wherein the at least one unsaturated bond is selected from a diene, an enone, or a terminal olefin;
ii) the hydrocarbon is selected from an oil including an unsaturated fatty acid, a glyceride, or combinations thereof; or
iii) the hydrocarbon is halogenated, or includes a ketone, or combinations thereof.

18. The digital printing composition as defined in claim 5 wherein:
i) the at least one unsaturated bond of the hydrocarbon is conjugated, and wherein the at least one unsaturated bond is selected from a diene, an enone, or a terminal olefin;
ii) the hydrocarbon is selected from an oil including an unsaturated fatty acid, a glyceride, or combinations thereof; or
iii) the hydrocarbon is halogenated, or includes a ketone, or combinations thereof.

19. The carrier as defined in claim 11 wherein the hydrocarbon is selected from an oil including an unsaturated fatty acid, a glyceride, or combinations thereof.

20. The carrier as defined in claim 11 wherein the hydrocarbon is halogenated, includes a ketone, or combinations thereof.
